(19) United States
(12) Patent Application Publication
(10) Pub. No.: US 2003/0047603 A1
(43) Pub. Date: Mar. 13, 2003

(54) Logistics scales

(76) Inventors: Martin Lustenberger, Villars-sur-Glane (CH); Wolfram Luithardt, Sugiez (CH)

Correspondence Address: JENKENS & GILCHRIST, PC, 1445 ROSS AVENUE, SUITE 3200, DALLAS, TX, 75202, US

(21) Appl. No.: 10/130,435

(22) PCT Filed: Sep. 3, 2001
(86) PCT No.: PCT/CH01/00529

(51) Int. Cl. G01G 19/42

(52) U.S. Cl. 235/385; 177/25.17

(57) ABSTRACT

The logistic balance according to the invention comprises any desired large number of racks (1), each rack (1) being set up to accommodate a specific number of containers of small parts or parts themselves. The rack (1), comprising a rack shelf (5) and two side walls (6), is borne by hooks (12) which are fixed to two frames (11). The hooks (12) engage in openings (13) in an L-shaped supporting part (7) in each case, on which in each case a frame plate (8) of a force measuring cell (9) rests. The rack shelf (5) in each case rests on a load sensing plate (10) of the two force measuring cells (9). By means of suitable algebraic linking of the measurement results from the two force measuring cells (9) obtained in evaluation electronics, the weights of the individual containers and their positions on the rack (1) can be determined. By means of suitable electronic interrogation means, in this way the stock and its changes can be monitored continuously and displayed in the current state.

The present invention relates to a weighing system for the management of a stock of parts, preferably small parts, in accordance with the preamble of patent claim 1.

When a large number of different parts is stored, and the stock turnover is high, the management of such stocks can be extremely complicated. For this purpose, use is made nowadays of data processing devices, which register the inflow and the outflow of parts—or packs of parts—so that the current stock can always be determined as the balance of inflow and outflow. The correctness of this balance assumes that the material flow is registered logically and relevantly. However, the possibilities for error are numerous; incorrect registration of documents produced in hand-written or machine-written form, mislaying or forgetting documents when goods are put into storage manually or the removal of parts, or the incorrect creation of such documents. In order to clean up such discrepancies, periodic inventories or stock checks are necessary. Between such inventories—provided they are carried out without error—certain uncertainties have to be tolerated.

U.S. Pat. No. 3,605,089 discloses a logistic balance in which each storage site or the storage area of each container used is equipped with a balance. In addition, the electronic interrogation and data processing means which are needed and provided for such a logistic concept are disclosed there. Although this solution is convenient, because of the large number of balances to be used, it is also complicated and expensive. In order to reduce the costs, pressure-dependent resistors as force sensors are proposed, which then have the disadvantage of relatively poor resolution and, on account of environmental influences, such as humidity and temperature, tend to drift to a great extent.

The object which is to be achieved with the present invention is to provide an aid which is not only able to register stock ingoings and outgoings seamlessly and correctly, but is also capable at any time of supplying a fault-free current value of a stock, preferably one of small parts. The supply of the data suitable for this purpose is additionally to take place at short time intervals and without active human intervention, so that ingoings and outgoings and stocks can be registered, documented and stored virtually permanently.

The achievement of the object set is reproduced in the characterizing part of patent claim 1 with regard to its substantial elements, and in the further patent claims with regard to further advantageous developments.

The idea of the invention will be explained in more detail using the associated drawing, in which

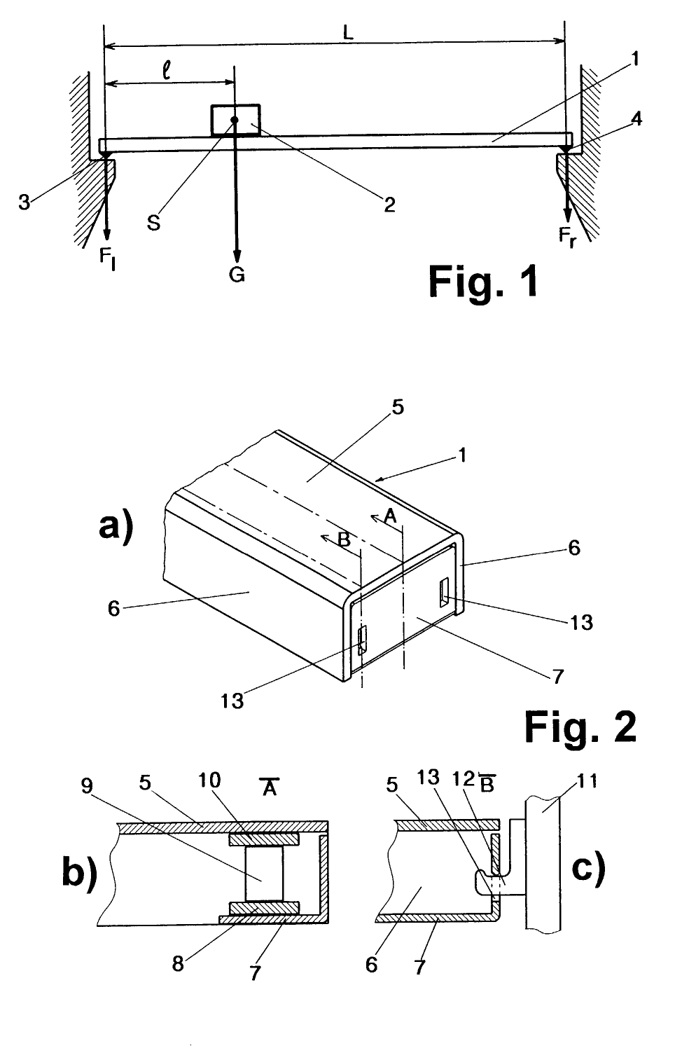

FIG. 1 shows the construction of the logistic balance according to the invention in a schematic way,

FIG. 2a shows a first exemplary embodiment in a perspective view,

FIG. 2b shows a first longitudinal section through FIG. 2a,

FIG. 2c shows a second longitudinal section through FIG. 2a,

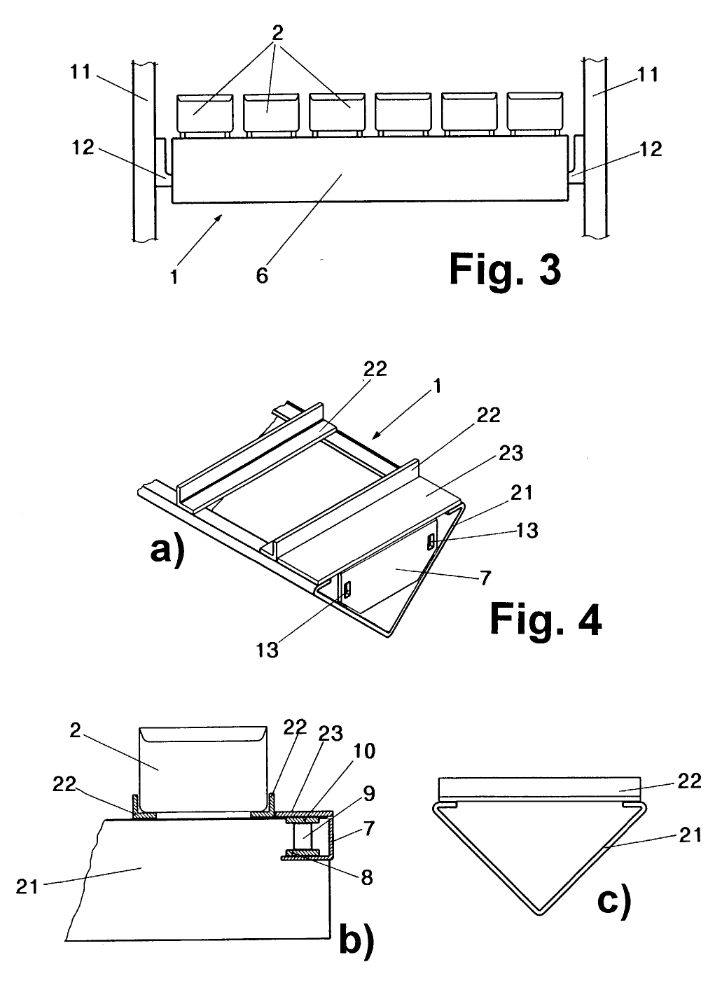

FIG. 3 shows a front view of the first exemplary embodiment,

FIG. 4a shows a second exemplary embodiment in a perspective view,

FIG. 4b shows a longitudinal section through FIG. 4a,

FIG. 4c shows a cross section through FIG. 4a,

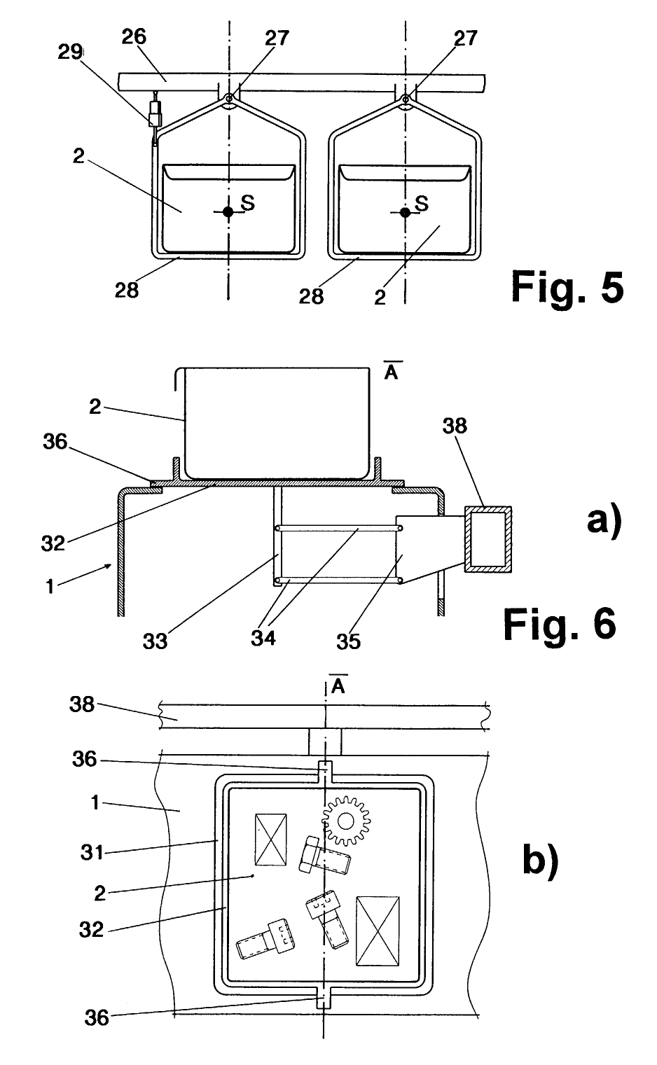

FIG. 5 shows a view of a third exemplary embodiment,

FIG. 6a shows a cross section through a fourth exemplary embodiment,

FIG. 6b shows a plan view of the exemplary embodiment of FIG. 6a.

In the schematic illustration of FIG. 1, a container 2 with weight G lies on a rack 1 of a small parts store, at the center of gravity S. The rack has an overall length L between two supports 3, 4 illustrated schematically as knife edges. The location of the container 2 is at a distance l from the left-hand support 3. If the support 3 is firstly considered as a virtual pivot, then the calculation of moments for the supporting force Fᵣ in the right-hand support 4 gives

$${F}_{r} = G \cdot \frac{l}{L} . \qquad ( 1 )$$

If this same consideration is applied to the right-hand support 4 as a virtual pivot, the result is the supporting force Fₗ in the left-hand support 3:

$${F}_{1} = G \frac{( L - l )}{l} \qquad ( 2 )$$

The sum of (1) and (2) can be formed immediately and, as is known, results in

Fᵣ+Fₗ=G (3)

If, however, the difference (1)-(2) is formed, then the result is

$${F}_{r} - {F}_{1} = G \frac{( 2 l - L )}{L} \qquad ( 4 )$$

which leads to the determination of l:

$$l = \frac{L}{2} ( \frac{{F}_{r} - {F}_{l}}{{F}_{r} - {F}_{l}} + 1 ) = L \frac{{F}_{r}}{{F}_{r} + {F}_{1}} \qquad ( 5 )$$

In order to determine the supporting forces Fₗ, and Fᵣ, according to the invention two weighing cells are provided—as shown in more detail in FIGS. 2 and 4.

If parts are then removed from the container 2, then equation (3) can be used immediately to determine the new weight of said container, and therefore also to determine the weight removed or added, and equation (5) permits the location of the container to be determined.

All the equations (1) to (5) are of course symmetrical and can immediately be transferred into one another, using elementary algebra, by exchanging the terms “left” and “right”.

If these lateral terms are neutralized and the following correspondences are inserted

l=l₁

L−l=l₂

Fₗ=F₁

Fᵣ=F₂,

then the result is the following transformations and generalizations of the equations:

$${F}_{1.2} = G \frac{{l}_{21}}{L} \qquad ( 1 , 2 )$$

F₁+F₂=G (3)

$$\begin{matrix}{F}_{1.2} - {F}_{2.1} = \frac{G}{L} ( L - 2 {l}_{1.2} ) & ( 4 ) \\ {l}_{1.2} = L \cdot \frac{{F}_{21}}{{F}_{1} + {F}_{2}} & ( 5 )\end{matrix}$$

Since the locations of the containers 2, in other words the magnitudes l_{1,2}, can only assume discrete values, or if applied to

$$\frac{{l}_{1 , 2}}{L}$$

can lie only in a finite countable set of true fractions, the number of the storage container can be found either from the values

$$\frac{{l}_{1}}{L} or \frac{{l}_{2}}{L} ,$$

via a simple algorithm. In order to increase the certainty, the algorithm can be applied redundantly both to

$$\frac{{l}_{1}}{L} and \frac{{l}_{2}}{L} .$$

FIGS. 2a, b, c are the representation of a first exemplary embodiment of the idea of the invention. Here, the rack 1 is designed as a sheet metal construction in the form of a U that is open at the bottom, having a rack shelf 5 and two side walls 6 serving for reinforcement. The elements designated by 5, 6 together form the loadbearing structure used in this exemplary embodiment. From both ends of the rack 1 (only the right-hand side, which is symmetrical to the left-hand side is illustrated) in each case there projects a substantially L-shaped supporting part 7 into the downwardly open U of the rack 1.

FIG. 2a shows a perspective view obliquely from above of the right-hand end of the rack 1.

FIG. 2b is a longitudinal section AA through the rack 1. Fixed to the horizontal leg of the L-shaped supporting part 7 is a frame plate 8 belonging to a force measuring cell 9 illustrated schematically. At the top, the force measuring cell 9 has a load sensing plate 10, on which the rack shelf 5 is fixed, likewise illustrated schematically.

In FIG. 2c, which represents a section BB, it can be seen how the rack 1 is hooked into two hooks 12 fixed to a frame 11, said hooks 12 engaging in two openings 13 in the vertical leg of the L-shaped supporting part 7.

FIG. 3 illustrates a rack 1 according to the exemplary embodiment of FIG. 2. Here, six containers 2 are provided. For practical reasons, the number of containers 2 per rack 1 is limited by

the smallest weight unit of the goods stored per container,

the maximum deviation possible by the stored goods of the center of gravity of a container 2 from its geometric center, in the lateral direction,

the resolution of the weighing cells and the reproducibility of the weighing results over long time periods.

This assumes that the location of each container 2 can be defined well, but this is generally possible with simple means. This maximum possible number of containers 2 per rack may be determined by means of simple variation calculations from equations (4, 5).

In addition to the means already mentioned—such as the electronic determination of the force F_{1,2}—a computer is provided and a selection or call-off system for the weighing results, either by means of direct addressing of the force measuring cells or of the—virtual—container number or by means of calling them sequentially via a known bus system.

The electronic data processing can then take place in various ways corresponding to the concrete application.

In principle, the force measuring cells considered are all those which are able to satisfy the requirements with regard to resolution, long-term stability and reproducibility of the weighing results, preferably but not exclusively those which operate on the vibrating string principle.

FIGS. 4a, b, c represent a second exemplary embodiment of the idea of the invention. Here, the rack 1 is constructed in such a way that a V-shaped bent metal sheet forms a loadbearing structure 21, onto which, for example, guide plates 22 bent in an L shape are welded, for example, transversely with respect to the opening in the V-shaped loadbearing structure 21. These guide plates 22 therefore constitute rails and are used firstly to stiffen the loadbearing structure 21 and secondly for the exact positioning of the containers 2. Provided at both ends of the loadbearing structure 21, as already explained in relation to FIGS. 2a, b, c, are supporting parts 7, each of which, via a frame plate 8, bears a load measuring cell 9 which, in turn, via a load sensing plate 10, bears a loadbearing element 23 which is strip-like, for example, and belongs to the loadbearing structure 21. The loadbearing element 23 is likewise welded, for example, onto the loadbearing structure 21.

Together with the folded-in edge of the loadbearing structure 21, the guide plates 22 form the element which is designated by “shelf” 5 in FIG. 2, although an actual shelf is not provided but is not ruled out either. The function of the side walls 6 from FIG. 2 is performed by the loadbearing structure 21. Manifold further developments of racks 1 can be conceived and implemented within the context of the knowledge of those skilled in the art. In the case of all, however, it is essential for the invention that the weight of the loadbearing structure in general and the differently loaded containers 2 located on it is absorbed via two force measuring cells 9 located at the ends of the rack 1 on the frame 11 or static loadbearing elements corresponding to it in functional terms.

A third exemplary embodiment is the subject of FIG. 5. Here, the loadbearing structure forming the rack 1 in functional terms is designed as a carrier 26 which, in turn (not depicted in the illustration) is supported via two force measuring cells 9 on a supporting part 7 in each case, for example by means of two hooks 12 in each case on the frame 11 or static elements corresponding to it in functional terms. The carrier 21 carries holding baskets 28 for the containers 2 at equal intervals, for example, on pivot bearings 27. This embodiment of the invention has the advantage that the center of gravity S of each container 2 always comes to lie exactly under a pivot bearing 27. Since the determination of the location of each container therefore becomes more accurate, the number of containers 2 per rack 1 can be increased with constant accuracy, reproducibility and resolution of the force measuring cells 9.

An addition included in the idea of the invention is likewise included in FIG. 5. A damper 29, shown schematically, connects the holding basket 28 (shown on the left in FIG. 5) to the carrier 26. This damper 29 has the task of damping the swinging movements of the holding basket 28 which virtually inevitably occur during the loading and unloading of the containers, specifically in such a way that after the swinging movement has decayed, no residual torque remains in the pivot bearing 27 or in the damper 29. Such dampers 29 are known per se, in various designs and acting on various principles. Here, the carrier 26 is likewise shown only schematically, since many solutions are possible from the knowledge of those skilled in the art.

FIGS. 6a, b show a fourth exemplary embodiment of the idea of the invention. Here, the rack 1 has a number of recesses 31, the number agreeing with the maximum possible number of containers 2. Each recess 31 accommodates, with sufficient spacing on all sides, a tray 32 on which the container 2 comes to stand. The tray 32 is firmly connected to a substantially vertical rod 33, which is guided in parallel by two links 34. These are in turn attached to a further substantially vertical rod 35, which is fixed to a rod 38 which runs parallel to the rack 1 and is fixed to the frame 11. In the region of the recess 31, for example, the tray 32 bears two stops 36 which are aligned with each other and which are supported on the rack 1—or, in more general terms, on the loadbearing structure.

If, in the case of the container 2, the center of gravity does not coincide with the geometric center, which is certainly the rule, then this produces a torque which is dissipated to the frame 11 via the rod 38. There remains the nett effective weight of the container 2, which then acts on a well defined point, namely the support of the stops 36. The further design of the ends of the rack is like that described in relation to FIG. 2 or 4.

Since the parallel guide comprising the elements 33, 34, 35 executes only virtual movements, it may consist of a sheet metal construction, for example stamped and bent. The hinges of the parallel guide can then be bending hinges, it being possible to ensure by means of adjustment that the stops 36 rest on the rack with exactly no force, or can be tared to zero, when the tray 32 is empty.

As an alternative to fixing the force measuring cells 9 to the rack 1, these can of course also be fixed to the frame 11 itself and, via the load sensing plate 10, can bear the hooks 12 or devices corresponding to the latter. In this way, the load introduction point is not displaced, but remains at the holding point of the rack 1 in the hooks 12.

An addition according to the invention to the exemplary embodiments previously described comprises a preferably optical blocking or release signal, that is to say a red and green signal lamp in each case: if a store is being loaded and/or unloaded, for example by two persons, then it is conceivable that two such loading and/or unloading operations are being carried out on the same rack 1, specifically in such a way that the two aforementioned processes overlap with regard to the measuring time.

Each system of force measuring cell 9 and associated evaluation electronics that can be used in the logistic balance according to the invention needs a certain time until a new force value is stable and determined within the predefined resolution. As a rule, the aforementioned evaluation electronics have rest monitoring, as it is known, which produces an enable signal when the newly determined force value meets the aforementioned criteria. This aforementioned enable signal can be used by means known per se to control a signal that can be perceived by the senses, that is to say an acoustic or preferably optical signal.

The point at which such an indicator, preferably comprising red and green signal lamps, is fitted is of course left up to pure expedience considerations, without leaving the idea of the invention, for which reason the depiction in the figures is also omitted.

1. A weighing system for managing a stock of parts, preferably small parts, in which the number of parts is determined via their weight, there are electronic data processing means both for the evaluation of the weights and their locations and also the actual stock management, and the store has an arbitrary but determined number of racks (1), characterized in that
each rack (1) is set up to accommodate a predefined number of parts or of containers (2) containing such parts,
each rack (1) has a horizontal loadbearing structure (5, 6, 21, 26), which bears the parts or containers (2),
each rack (1) has at each of its ends a supporting part (7), which can be hooked into suspension means (12) borne at least indirectly by a frame (11),
for each rack (1) there are two force measuring cells (9).

2. The weighing system as claimed in patent claim 1, characterized in that
each supporting part (7) bears a force measuring cell (9), which is fixed to it,
the horizontal loadbearing structure (5, 6, 21, 26) is supported at each of its ends on one of said force measuring cells (9) in each case and is fixed to it, it being possible both for the weight of the parts or of the containers (2) and their locations to be determined by means of the suitable algebraic combination of the measurement results from the two force measuring cells (9).

3. The weighing system as claimed in patent claim 1, characterized in that
each one of the two force measuring cells (9) is fixed to one side of the frame (11) in each case and is supported on the latter and bears the suspension means (12),
the horizontal loadbearing structure (5, 6, 21, 26) is supported at each of its ends on one of said supporting parts (7) and is fixed to it, the supporting parts (7) transmitting the weight to be measured to the suspension means (12) and it being possible both for the weight of the parts or containers (2) and their locations to be determined by means of the suitable algebraic combination of the measurement results from the two force measuring cells (9).

4. The weighing system as claimed in patent claim 2 or 3, characterized in that each weighing cell (9) is connected individually to the data processing means.

5. The weighing system as claimed in patent claim 2 or 3, characterized in that there is a bus system which interrogates the individual weighing cells (9) one after another.

6. The weighing system as claimed in patent claim 4 or 5, characterized in that the horizontal loadbearing structure comprises a horizontal shelf (5), which has side walls (6) that point downward, and the parts or the containers are placed on this shelf (5).

7. The weighing system as claimed in patent claim 6, characterized in that the shelf is provided with rails (22) running transversely with respect to its longitudinal extent.

8. The weighing system as claimed in patent claim 4 or 5, characterized in that
the horizontal loadbearing structure (21) consists of a V-shaped metal sheet open at the top and having folded-in edges,
rails (22) are fixed to the folded-in edges, transversely with respect to the longitudinal extent of the loadbearing structure (21), in order to accommodate containers (2).

9. The weighing system as claimed in patent claim 4 or 5, characterized in that
on the loadbearing structure (5, 6, 21, 26), a number of trays (32) corresponding to the number of containers (2) to be accommodated is arranged,
each tray (32) is fixed to a vertical rod (33),
there is a rod (38) which runs parallel to the loadbearing structure (5, 6, 21, 26) and is fixed to the frame (11) and is substantially horizontal,
there is in each case a further vertical rod (35) which is fixed to the horizontal rod (38),
there are in each case two mutually substantially parallel links (34) which are attached both to the first and to the second vertical rod (33, 35), so that each tray (32) is guided parallel to the first vertical rod (33) by the links (34),
there is at least one stop (36) which is at least indirectly connected to the first vertical rod (33) and which is supported on the loadbearing structure.

10. The weighing system as claimed in patent claim 9, characterized in that the parallel guide comprising the first and second rod (32, 35) and links (34) is a sheet metal construction with bending hinges, which are set up in such a way that the at least one stop (36) is supported on the loadbearing structure without force, or can be tared to zero, when the tray (33) is empty.

11. The weighing system as claimed in patent claim 4 or 5, characterized in that on pivot bearings (27) whose horizontal axes run transversely with respect to the extent of the loadbearing structure, the horizontal loadbearing structure in each case bears a holding basket (28) which can be pivoted in the pivot bearing (27) in order to accommodate parts or containers (2).

12. The weighing system as claimed in patent claim 11, characterized in that for each holding basket (28) there is a damper (29) in order to damp its swinging movements, said damper being such that after said swinging movement has decayed, no residual torque remains either in the pivot bearing (27) or in the damper (29).

13. The weighing system as claimed in one of patent claims 1-12, characterized in that the force measuring cells (9) are those which operate on the vibrating string principle.

14. The weighing system as claimed in one of patent claims 1-13, characterized in that
for each rack there is an indicating device which indicates whether a weight determination process has been completed or is continuing,
by means of the electronic data processing means, an enable signal is generated from the rest monitor of each pair of force measuring cells (9) used for one rack (1), when a weight determination process has been completed,
said enable signal is able to control the indicating device in such a way that there follows a signal for enable or non-enable which can be perceived by the senses.

15. The weighing system as claimed in patent claim 14, characterized in that the enable signal comprises a green signal lamp, and the non-enable signal comprises a red signal lamp.
